(19) United States
(12) Patent Application Publication
(10) Pub. No.: US 2009/0313379 A1
(43) Pub. Date: Dec. 17, 2009

(54) Topology Hiding Of Mobile Agents

(75) Inventors: Gunnar Rydnell, Frölunda (SE); Tomas Goldbeck-Löwe, Stockholm (SE); Stefan Rommer, Göteborg (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/307,507

(22) PCT Filed: Jul. 3, 2006
(86) PCT No.: PCT/EP06/06453

§ 371 Date: Jan. 5, 2009

(51) Int. Cl. H04L 29/06

(52) U.S. Cl. 709/228; 713/150

(57) ABSTRACT

A method, infrastructure node (11, 12, 202), and mobile node (1) arranged to hide topology information from the user and mobile node by translating topology information to non-topology related address information and using session management messages of a first communication protocol as bearer for Internet Protocol mobility messages relating to a second communication protocol.

### TECHNICAL FIELD

The present invention relates to packet communication in a mobile environment and in particular to a method, infrastructure node, mobile node and network in a mobile IP enabled network.

### BACKGROUND OF THE INVENTION

In the ever increasing mobile communication arena packet data based communication protocols are becoming increasingly important. The users have a desire to be able to communicate when and where they chose and preferably with mobility possibilities. In order to provide high quality communication for the users, the service providers are providing a multitude of communication protocols and the devices used for communication also have a multitude of communication interfaces. However, the users have a desire to keep connections open when changing between different communication protocols and/or different communication gateways (such as different base stations or wireless access points). For this purpose different solutions has been proposed for handling roaming and handover between different communication gateways when the user moves from one location to another. One such solution involves an Internet Protocol (IP) for mobility, the so called Mobile IP standard (MIP).

Mobile IP (v4 and v6) is a protocol defined by IETF that allows IP packets to reach a mobile node independent of where the mobile node attaches to an IP network, e.g. the Internet. Without Mobile IP (or alternate mobility solution), packets destined to a mobile node's IP address will be routed using the regular IP routing mechanisms to the network where the IP address is topologically located (the “home network”). However, a mobile node may, when away from home, connect to a different network. Mobile IP solves the routing problem by introducing a mobility agent at the home network (“Home Agent”) that registers the current location of the mobile node and forwards all traffic that arrives at the home network to the mobile nodes current point of attachment, the so-called Care-of-Address.

Work is ongoing in 3GPP to define multi access mobility to integrate 3GPP with non-3GPP access technologies. MIP is a candidate that is considered in 3GPP to solve multi access mobility.

In Mobile IP, IP addresses are used extensively to identify the different actors such as Home Agent (HA), Foreign Agent (FA) and Mobile Node (MN). Those IP addresses may reveal information about the network topology, the number of network entities etc. If Mobile IP is deployed in commercial scale in 3G mobile networks, this is a problem. The mobile operators traditionally want to hide such information from competitors. If MIP shall be used as multi access mobility protocol in 3GPP, it would therefore be beneficial if Mobile IP could be deployed without revealing IP address information about the core network entities.

Even though the MIP client in the terminal knows the address it does not mean the address is directly visible to the end-user, the MIP client does not need to be available to the end-user. But, it is possible to hack an application in a laptop and also to hack the phone to reveal information.

In some cases, it may be accepted to exchange IP address information, e.g. between trusted roaming partners. However, it should be avoided to reveal such information to anyone, in particular to end-users. As an example, in a GPRS network, the IP addresses of the SGSN and GGSN entities are not known by the end-user terminal. The IP addresses may however be known by roaming partners.

The table below shows which entities know about different IP addresses. A “*” indicates where an IP address of a core network entity is revealed to the end user.

| | MN | FA | HA |
|---|---|---|---|
| MN Care-of-Address | X* | X | X |
| MN Home Address | X | X | X |
| FA IP address | X* | X | X |
| HA IP address | X* | X | X |

### SUMMARY OF THE INVENTION

The object of the present invention is to provide such a tool that remedies some of the above mentioned problems, this is done in a number of ways wherein according to a first aspect, a communication infrastructure node in a mobile communication network is provided, and arranged to communicate with at least one mobile node with a first communication protocol and at least one host server, the infrastructure node further arranged to communicate with the mobile node with a second communication protocol in a packet based mobility enabled network, the infrastructure node comprising a processor arranged with functionality for acting as a Care-of-Address (CoA) identifying device for connecting a host address in the second communication protocol to a network identifier for hiding network topology information in the second communication protocol network for the mobile node connected to the infrastructure node and the processor further arranged to use session management signaling of the first communication protocol as bearer of Internet Protocol (IP) based mobility control information of the second communication protocol. The network identifier may optionally be temporary.

The node may be arranged to receive registration request information sent from the mobile node together with session management information. The node may be further arranged to send registration response information to the mobile node together with session management information.

The network identifier may be arranged as to be translated using at least one of a domain name server (DNS) or AAA server (Authentication, Authorization, and Accounting). The session management signaling may be a Packet Data Protocol (PDP) context. The session management signaling may be at least one of IKE (Internet Key Exchange) and IPSec (IP security protocol) SA (Security Association).

The node may be further arranged to replace a home agent IP address from a packet header in a data packet before forwarding the data packet to the mobile node. The node may be further arranged to recalculate a checksum, based on home agent IP address, provided in data packets forwarded to the mobile node.

The packet based mobility protocol may be at least one of Mobile Internet Protocol, i.e. MIP, Host Identity Protocol, i.e. HIP, or IKEv2 Mobility and Multihoming, i.e. MOBIKE.

According to a second aspect of the present invention, a method for hiding topology information in a mobile communication network is provided, comprising a first and second communication protocol, the method comprising the steps of:
translating in an infrastructure node a host Internet Protocol (IP) Address in the second communication protocol into a second address not containing topology information;
using session management messages for the first communication protocol in the mobile communication network for distributing mobility IP control information of the second communication protocol between the infrastructure node and a mobile node.

The method may be arranged to receive registration request information sent from the mobile node together with session management messages. The method may be further arranged to send registration response information to the mobile node together with session management messages.

The network identifier may be arranged as to be translated using at least one of a domain name server (DNS) or AAA server (Authentication, Authorization, and Accounting).

The session management message may be a Packet Data Protocol (PDP) context.

The session management message may be at least one of IKE (Internet Key Exchange) and IPSec (IP security protocol) SA (Security Association).

The method may be arranged to replace a home agent IP address from a packet header in a data packet before forwarding the data packet to the mobile node. The method may be arranged to recalculate a checksum, based on home agent IP address, provided in data packets forwarded to the mobile node.

The second communication protocol may be at least one of Mobile Internet Protocol, i.e. MIP, Host Identity Protocol, i.e. HIP, or IKEv2 Mobility and Multihoming, i.e. MOBIKE.

A third aspect of the present invention, a mobile node for use in a mobile communication network is provided, wherein the mobile node is arranged with processing means for connecting to an infrastructure node in the communication network with specific session management control messages for a first communication protocol for the mobile communication network and adding mobile, Internet Protocol, i.e. IP, control messages for a second communication protocol to the session management messages.

The second communication protocol may be at least one of Mobile Internet Protocol, i.e. MIP, Host Identity Protocol, i.e. HIP, or IKEv2 Mobility and Multihoming, i.e. MOBIKE.

One of the advantages of the present invention is thus that it is possible to hide topology information about the infrastructure from the user or user equipment which is of interest of the network owners and operators.

These and other aspects of the invention will be apparent from and elucidated with reference to the embodiments described hereinafter.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates schematically a communication network according to the present invention;

FIG. 2 illustrates schematically a Mobile IP communication topology;

FIG. 3 illustrates schematically in A a use case diagram of a link establishment and in B a block diagram of a method of link establishment according to the present invention;

FIG. 4 illustrates schematically in a block diagram an infrastructure node according to the present invention;

FIG. 5 illustrates schematically in a block diagram a mobile node according to the present invention; and

FIG. 6 illustrates schematically a network structure according to another embodiment of the present invention.

### DETAILED DESCRIPTION OF PREFERRED EMBODIMENTS

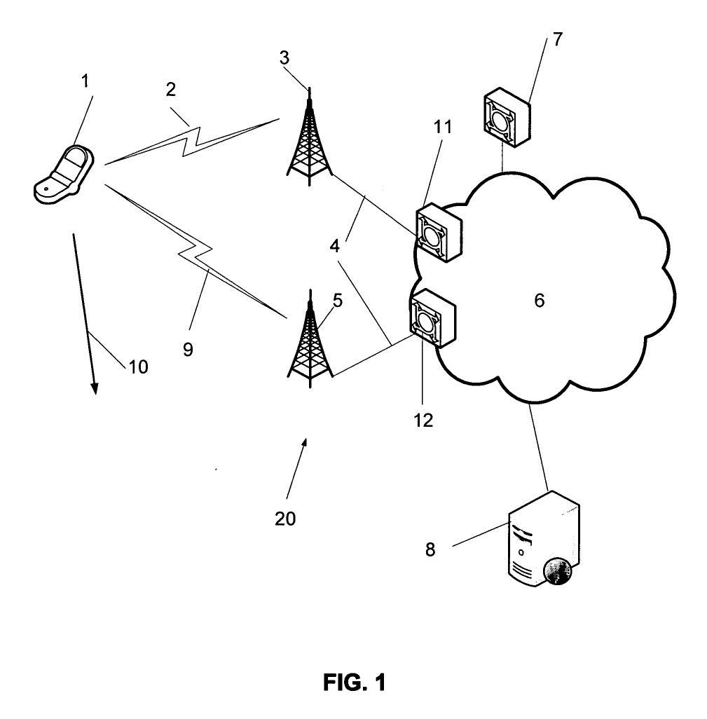

In FIG. 1 reference numeral 1 generally denotes a mobile node 1 (MN) according to one embodiment of the present invention. The mobile node 1 communicates 2 with a communication network 20 comprising one or several communication gateways 3, 5 in connection with communication control nodes 11,12 forming part of or attached to an infrastructure network 6 for instance an IP-based network (Internet Protocol). To the communication network 20 a home location server 7 is provided to which the mobile node 1 has a logical attachment to. Also different application servers 8 may be connected to the infrastructure network 6, for instance providing web services, email, file storing and other well known services provided over the Internet or similar IP based networks.

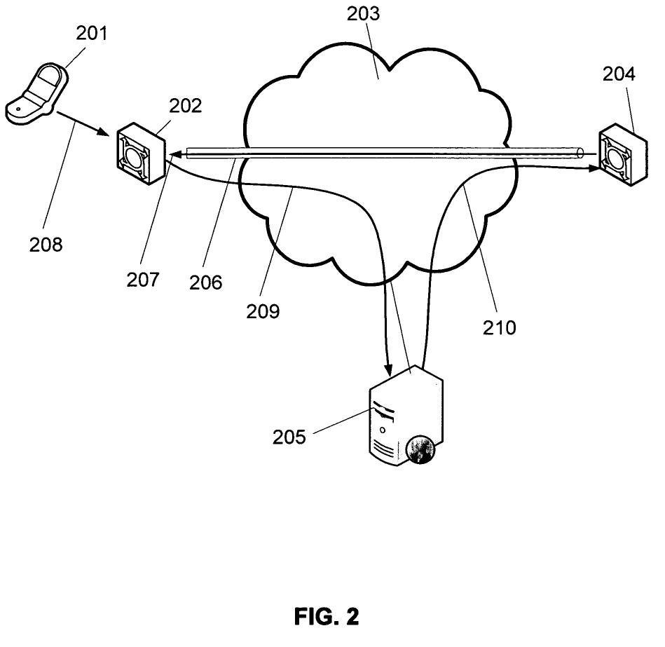

The present invention concerns a communication method for mobile nodes that connect to communication gateways different from a set home location to which the mobile node is logically attached, it is in these cases interesting for the user of the mobile node to be able to connect even though it is not in the home network and still maintain a mobile environment, i.e. for instance when moving 10 from one gateway 3 to another gateway 5 and thus changing communication path 9 while still keeping an established connection to an application server 8. This kind of mobility protocol is for instance provided for by Mobile IP (MIP), which is well known in the art. FIG. 2 illustrates the MIP environment as often discussed from the standard. The mobile node 201 communicates 208 with an application server 205 located for instance on the Internet 203. In doing this, the mobile node 201 has to connect to a local service provider in the area, i.e. to a server acting as a so called Foreign Agent (FA) 202. The FA sends 209 all data messages intended for the application server 205 to the application server via the network 203. In the header of the data message an address of the mobile node is provided; however, since the mobile node 201 is mobile it might have changed FA 202 before any return messages are sent back to the mobile node 201. Therefore, the address in the header is the home address (i.e. the home location server 204 to which the mobile node is logically attached). This home location server is called Home Agent (HA) 204. Data traffic is therefore sent 210 to the HA which in turn redirects 207 messages to the last known FA using for instance an IP tunnel 206.

Returning now to FIG. 1, in which communication control nodes 11 and 12 are assumed to act as foreign agents and node 7 as a home agent in a MIP enabled network. For instance if the mobile node 1 connects to an application server 8 on the Internet 6 traffic from the application server 8 will be transferred via the home agent 7 to the foreign agent 11, 12 to which the mobile node currently is connected to (or at least to the foreign agent that the home agent has currently registered as the foreign agent the mobile node is connected to).

The main objective of the present invention is to hide topology information of the infrastructure network, for instance IP address information about Foreign Agent and Home Agent to the end-user terminal (Mobile Node), but also hide information about other infrastructure components that may be involved in the communication protocol. The invention accomplishes this in two steps:
Piggy-backing MIP registration requests (RRQ) and responses (RRP) on top of access technology specific session management (SM) messages by adding these MIP control packets to the session management messages. This allows the FA IP address to be hidden from the MN. The exact SM messages used depend on the access technology. For example, 3G radio technologies use PDP context request and response messages. I-WLAN may use IKEv2 and/or IPSec messages (see below).
Utilizing Home Agent (HA) identifiers other than the IP address. An example is to use the HA NAI (RFC 3846). The core network will then be able to find the HA IP address by using e.g. DNS and/or AAA services. The HA identifier could be temporary in the sense that the HA may assign a new identifier when a registration is processed. The HA identifier could also be different for each MN. This allows the HA IP address to be hidden from the MN, which only is aware of a (temporary) HA alias. Note that this use of a (temporary) HA identifier differs from the usage proposed in RFC 3846.

With session management messages is meant control messages that are used for setting up the mobile node's connection to the infrastructure.

It should be noted that some access technologies reveal the IP address of the access edge node. For example, I-WLAN (Interworking-Wireless Local Area Network) mobile nodes know the IP address of a PDG (Packet Data Gateway). For these access technologies there may be limited benefits with hiding the FA IP address if the FA is located in the PDG.

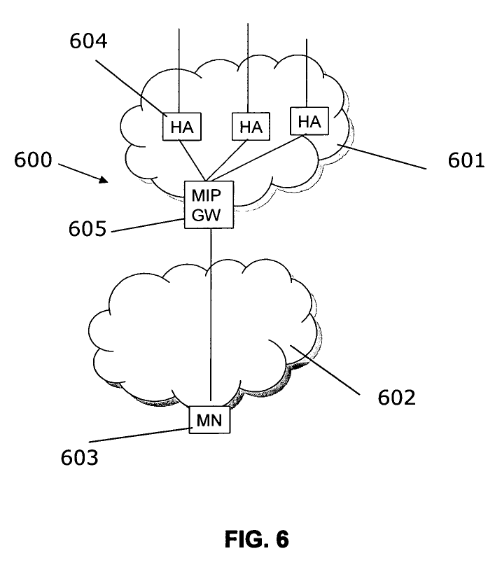

The present invention as exemplified in the above embodiment works for MIP v4 where a Foreign Agent Care-of Address (FA CoA) is used. In an IPv6 network a different approach may be used for instance using NAPT (Network address port translation) and/or ALG (Application Layer Gateway) functionality. The process of getting a care-of-address is much simpler in MIPv6 using IPv6 with stateless auto configuration or with auto configuration using DHCPv6 (Dynamic Host Configuration Protocol), since there is no foreign agent care-of-address, only collocated care-of-addresses will be used. It is also possible to use different IPv6 functionality to improve operation of mobile nodes, for instance, home agents may use the functionality of neighbor discovery and its proxy advertisement to intercept data packets intended for the mobile node. The situation for a system not using an FA will be described in more detail in relation to FIG. 6 later in this document.

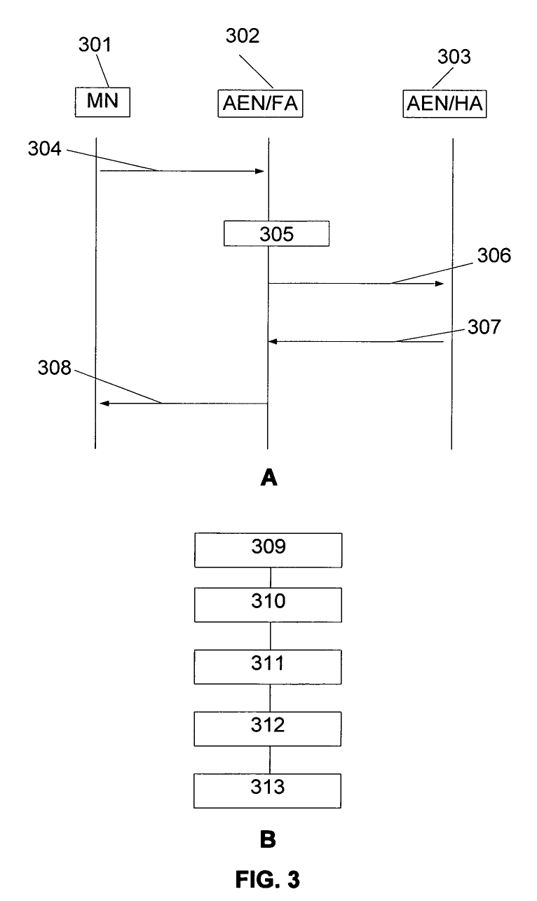

An implementation of MIP over GTP (GPRS tunneling protocol) is shown illustrated in FIG. 3a as a use case diagram and in FIG. 3b as a block diagram. Reference numeral 301 shows a mobile node, 302 an access edge node (AEN) with foreign agent functionality (FA) and 303 an access edge node (AEN) with home agent functionality (HA). Arrows indicate communication directions. MIP registration over 3GPP radio access is shown where a PDP context concept is used for session management. Other accesses such as I-WLAN where IKEv2 (Internet Key Exchange) and IPSec (IP security protocol) SA:s (security association) may be used as an alternative depending on type of communication access technology. The invention is not limited to IKE version 2, but other IKE versions may be used as understood by the person skilled in the art. Note that any interaction with AAA (authentication, authorization and accounting) infrastructure is not shown. However, the invention may operate together with any suitable AAA implementation, e.g. radius, diameter, or proprietary solutions.

The AEN (Access Edge Node) exemplifies a Packet Core Network Node, typically an evolved GSN (GGSN or GSN+); however, other network nodes may be used for implementing the same type of functionality providing session management functions, e.g. an Access Core Gateway (ACGW).

304. (309) The MN sends the “Activate PDP Context Request” to the Serving AEN. A MIP RRQ is included in the message. Piggybacking RRQ on GPRS SM (TS 24.008) and GTP (TS 29.060) messages could e.g. be done using Protocol Configuration Options Information Elements. The RRQ includes an identity of the HA. This identity was sent to the mobile node at the first registration the mobile node did with the HA.

Selection of HA when accessing the first time could be policy based and done by methods not covered by this invention. The message might include various other parameters. Router advertisements to announce the presence of an FA is not used. Instead it is assumed that the access gateway (serving AEN) has FA functionality. If S-AEN does not have FA functionality, the MN will find that the Activate PDP Context response (message 308) does not contain an RRP.

305. (310) The FA uses the HA identifier included in the RRQ to find the HA IP address. This could be done using e.g. DNS and/or AAA. The HA identifier could be temporary to further hide the topology and changed e.g. each time the user registers.

306. (311) The FA forwards the MIP RRQ to the HA.

307. (312) The HA responds with a MIP RRP.

308. (313) The AEN/FA includes the RRP into the “Activate PDP context response”. Piggybacking RRP on GPRS SM (TS 24.008) and GTP (TS 29.060) messages could e.g. be done using Protocol Configuration Options Information Elements. The FA removes or replaces the HA IP address field in order to hide the address from the MN. (Note 1 below). The MN home address is assigned using this message.

Note 1: This may affect the MIP protocol when using a separate IP address specifically assigned to the mobile node, since the HA IP address is included in the checksum. One solution to this may be for the FA to recalculate a new checksum after changing/removing the address. However, when using a collocated IP address, i.e. an address dynamically received from e.g. a DHCP server, packets may be unwrapped by the foreign agent and forwarded by the FA to the mobile node without recalculating any checksum in the packet. The invention allows an operator to deploy Mobile IP without revealing IP address information about the MIP core network entities to end-user terminals and thereby to competitors.

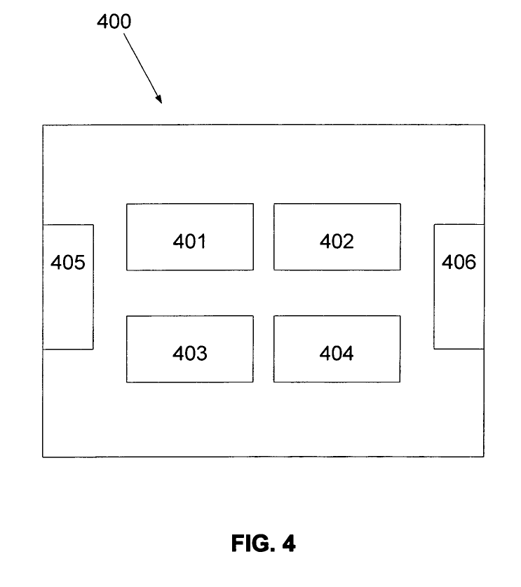

Another advantage of the invention is that all procedures and messages can be specified by 3GPP. The MIP protocol from IETF need not be affected (however, see note 1 above). Turning now to FIG. 4, illustrating in a schematic block diagram a service node according to the present invention, wherein a processing unit 401 handles communication data and communication control information. The service node 400 further comprises a volatile (e.g. RAM) 402 and/or non volatile memory (e.g. a hard disk or flash disk) 403, an interface unit 404. The service node 400 may further comprise a mobile communication unit 405 and backbone communication unit 406, each with a respective connecting interface. All units in the service node can communicate with each other directly or indirectly through the processing unit 401. Software for handling communication to and from the mobile units attached to the network is at least partly executed in this node and may be stored in the node as well; however, the software may also be dynamically loaded upon start of the node or at a later stage during for instance a service interval. The software can be implemented as a computer program product and distributed on a removable computer readable media, e.g. diskette, CD-ROM (Compact Disk-Read Only Memory), DVD (Digital Video Disk), flash or similar removable memory media (e.g. compactflash, SD secure digital, memorystick, miniSD, MMC multimediacard, smartmedia, transflash, XD), HD-DVD (High Definition DVD), or Bluray DVD, USB (Universal Serial Bus) based removable memory media, magnetic tape media, optical storage media, magneto-optical media, bubble memory, or distributed as a propagated signal via a computer network (e.g. Internet, a Local Area Network (LAN), or similar networks).

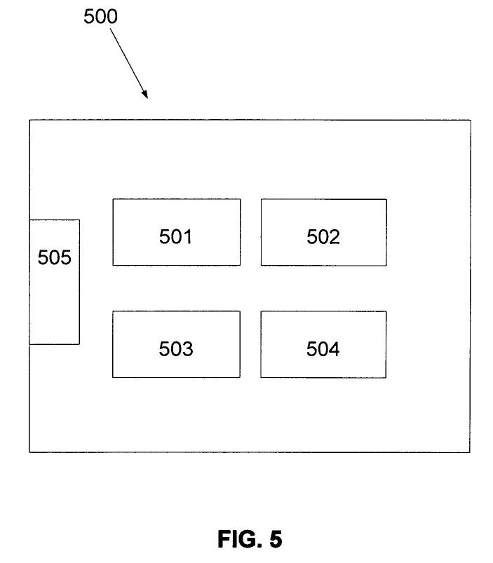

FIG. 5 illustrates in a schematic block diagram a mobile node according to the present invention, wherein a processing unit 501 handles communication data and communication control information. The mobile node 500 further comprises a volatile (e.g. RAM) 502 and/or non volatile memory (e.g. a hard disk or flash disk) 503, an interface unit 504. The mobile node 500 may further comprise a mobile communication unit 505 with a respective connecting interface. All units in the mobile node can communicate with each other directly or indirectly through the processing unit 501. Software for implementing the method according to the present invention may be executed within the mobile node 500. The mobile node 500 may also comprise an interface for communicating with an identification unit, such as a SIM card, for uniquely identifying the mobile unit in a network; however, these features are not shown in FIG. 5 since they are understood by the person skilled in the art.

FIG. 6 illustrates a network solution not using a foreign agent (FA). FA is optional for MIPv4 and MIPv6 is defined completely without FA. In both these cases a co-located CoA is used. The mobile node (MN) 603 connects to a foreign network 602 and establishes a connection with its home agent (HA) 604. A MIP gateway acts as an intermediate communication device in the home network 601. A user-plane (UP) tunnel goes between MN 603 and HA 604. To extend the invention to these two scenarios, the MIP Gateway (MIP GW) 605 may be introduced that in some sense replaces the FA in order to hide at least part of the core network 601 topology and IP addresses. The MIP GW 605 would typically be collocated with an AEN/GGSN (not shown).

The MN 603 will be assigned an HA 604 by some means (e.g. offline configuration or during access setup, this is not specified by the invention). The HA 604 is uniquely identified using an HA NAI (as described previously in this document) that is delivered to the MN 603. The MN 603 will also receive an “HA IP address” that actually belongs to the MIP GW 605 (i.e. the MIP GW acts as NAT/NAPT)

MIP signaling messages (e.g. RRQ and BU (binding update) etc) can be piggy-backed in access specific SM messages as described previously in this document according to the present invention. The MIP GW (AEN/GGSN) 605 resolves the HA NAI (using e.g. AAA or internal DNS) and forwards the messages to the correct HA.

For MIPv6, the signaling messages are protected by IPSec ESP (Encapsulating Security Payload) between MN 603 and HA 604. This means that the MIP GW 605 will not be able to look into any messages to read the HA NAI. A solution is to let the MIP GW be the IPSec tunnel endpoint for all MIPv6 signaling. The communication between MIP GW and HA's takes place on a private network. Another solution is to not protect MIPv6 signaling messages using IPSec, for instance by encapsulating MIPv6 signaling messages in a secure fashion in the SM messages.

User plane (UP): Without an FA, the UP tunnel goes between MN and HA. If the MIP GW acts as a NAT/NAPT, the HA IP addresses may be hidden from the MN. The MIP GW (NAPT) needs to have a mapping between the HA IP address upstream (i.e. between the HA and the MIP GW in FIG. 6) of the MIP GW and the HA IP address downstream of the MIP GW (i.e. between the MIP GW and the MN). The MN 603 only knows about the IP address on the downstream part of the network 600. A problem is that the UP traffic may optionally be protected by IPSec between MN and HA. A solution is that the HA uses the MIP GW IP address (downstream HA IP address) when it encrypts/decrypts and authenticates the UP traffic. Another potential solution is that the MIP GW encrypts/decrypts UP traffic.

The above discussion has been conducted with Mobile IP as an example; however, other mobility protocols may be used which are based on a host concept, e.g. Host identity protocol (HIP) or MOBIKE (IKEv2 Mobility and Multihoming).

It should be noted that the word “comprising” does not exclude the presence of other elements or steps than those listed and the words “a” or “an” preceding an element do not exclude the presence of a plurality of such elements. The invention can at least in part be implemented in either software or hardware. It should further be noted that any reference signs do not limit the scope of the claims, and that several “means”, “devices”, and “units” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

### DEFINITIONS

AEN Access Edge Node

FA Foreign Agent

GTP GPRS Tunneling Protocol

GSN GPRS Support Node

HA Home Agent

I-WLAN Interworking WLAN

MIP Mobile IP

MN Mobile Node

RRP Registration Response

RRQ Registration Request

1. A communication infrastructure node for a mobile communication network, arranged to communicate with at least one mobile node using a first communication protocol and at least one host server, the infrastructure node further arranged to communicate with the mobile node with a second communication protocol in a packet based mobility enabled network, the infrastructure node comprising:
a processor arranged with functionality for acting as a Care-of-Address identifying device for connecting a host address in the second communication protocol to a network identifier excluding network topology address information in the second communication protocol network and the processor further comprising means to use session management signaling of the first communication protocol as bearer of Internet Protocol (IP) based mobility control information of the second communication protocol.

2. The node according to claim 1, further comprising a receiving portion for receiving registration request information sent from said mobile node together with session management information.

3. The node according to claim 2, further comprising a transmitting portion to send registration response information to said mobile node together with session management information.

4. The node according to claim 1, further comprising means to translate said network identifier using at least one of a domain name server (DNS) or Authentication, Authorization, and Accounting (AAA) server

5. The node according to claim 1, wherein said session management signaling is a Packet Data Protocol (PDP) context.

6. The node according to claim 1, wherein said session management signaling is at least one of Internet Key Exchange (IKE) and IP security protocol (IPSec) Security Association (SA).

7. The node according to claim 1, further comprising means to replace a home agent IP address from a packet header in a data packet before forwarding said data packet to said mobile node.

8. The node according to claim 1, further comprising means to recalculate a checksum, based on home agent IP address, provided in data packets forwarded to said mobile node.

9. The node according to claim 1, wherein the packet based mobility protocol is at least one of Mobile Internet Protocol, i.e. MIP, Host Identity Protocol, i.e. HIP, or IKEv2 Mobility and Multihoming, i.e. MOBIKE.

10. The node according to claim 1, wherein the network identifier is temporary.

11. A method for hiding topology information in a mobile communication network comprising a first and second communication protocols, said method comprising the steps of:
translating in a node of said network a host Internet Protocol (IP) Address in the second communication protocol into a second address excluding network topology address information; and
using one or several session management messages for the first communication protocol in the mobile communication network for distributing mobility IP control information of the second communication protocol between said node and a mobile node.

12. The method according to claim 11, arranged to receive registration request information sent from said mobile node together with session management messages.

13. The method according to claim 12, further arranged to send registration response information to said mobile node together with session management messages.

14. The method according to claim 11, wherein said network identifier is arranged as to be translated using at least one of a domain name DNS or AAA server.

15. The method according to claim 11, wherein said session management message is a Packet Data Protocol (PDP) context.

16. The method according to claim 11, wherein said session management message is at least one of IKE and IPSec SA.

17. The method according to claim 11, arranged to replace a home agent IP address from a packet header in a data packet before forwarding said data packet to said mobile node.

18. The method according to claim 11, arranged to recalculate a checksum, based on home agent IP address, provided in data packets forwarded to said mobile node.

19. The method according to claim 11, wherein the second communication protocol is at least one of Mobile Internet Protocol, i.e. MIP, Host Identity Protocol, i.e. HIP, or IKEv2 Mobility and Multihoming, i.e. MOBIKE.

20. A mobile node for use in a mobile communication network, wherein said mobile node comprises processing means for connecting to an infrastructure node in said communication network with specific session management control messages for a first communication protocol for said mobile communication network and adding mobile Internet Protocol, i.e. IP, control messages for a second communication protocol to said session management messages, wherein control messages of the second communication protocol comprise a host server identifier excluding network topology address information.

21. The mobile node according to claim 20, wherein the second communication protocol is at least one of Mobile Internet Protocol, i.e. MIP, Host Identity Protocol, i.e. HIP, or IKEv2 Mobility and Multihoming, i.e. MOBIKE.
